(19) United States
(12) Patent Application Publication
(10) Pub. No.: US 2023/0034068 A1
(43) Pub. Date: Feb. 2, 2023

(54) TELESCOPIC DOCKING STATION

(71) Applicant: Shenzhen Dingzhen Technology Co., Ltd., Shenzhen (CN)

(72) Inventor: Yanling CHEN, Shenzhen (CN)

(73) Assignee: Shenzhen Dingzhen Technology Co., Ltd., Shenzhen (CN)

(21) Appl. No.: 17/964,199

(22) Filed: Oct. 12, 2022

(30) Foreign Application Priority Data
Aug. 17, 2022 (CN) 202222017802.6

(51) Int. Cl. H02J 7/00; H01R 13/72

(52) U.S. Cl. CPC H02J 7/0042; H01R 13/72; H02J 2207/30

(57) ABSTRACT

A telescopic docking station. It includes a docking station chassis. A mounting cavity is provided inside the docking station chassis. A charging circuit board is mounted inside the mounting cavity. A charging power cable and a plurality of charging data cables are connected to the charging circuit board. There is a cable receiver inside the mounting cavity corresponding to the number of charging cables. The rewind box is used to reel in the charging data cables. A top cover is mounted on the top of the mounting cavity. Just pull out the plug of the corresponding charging cable to use the docking station. It will allow users to charge their electronic devices if they forget to carry the cable; and when it is not in use, it will reel in the charging cable through the rewind box to avoid the charging cable from being scattered in confusion.

### CROSS-REFERENCE TO RELATED APPLICATIONS

The application claims priority to Chinese patent application No. 202222017802.6, filed on Aug. 17, 2022, the entire contents of which are incorporated herein by reference.

### TECHNICAL FIELD

A telescopic docking station relates to the technical field of automotive products.

### BACKGROUND

With the popularization of car electrification, in order to make the car can be external game host, VLOG shooting equipment, etc., to meet the owners of entertainment and social needs, and effectively extend the time of the user to stay in the car, the existing car sub-dashboard is the main area of the entire car set external interface and storage. But it has the following defects. Most current models have a separate USB port on the sub-instrument, but it requires the user to carry a data cable to charge electronic devices such as cell phones, and if the user forgets to carry a data cable it is impossible to charge electronic devices. It cannot meet the daily needs of users. In addition, the data cable is easily lost when it is scattered outside. Therefore, we improve it and introduce a telescopic docking station.

### SUMMARY

In order to solve the above technical problems, the invention provides the following technical solutions.

A telescopic docking station, including a docking station chassis, the docking station chassis is provided with a mounting cavity, the interior of the mounting cavity is installed with a charging circuit board, the charging circuit board is connected with a charging power cable and a plurality of charging data cables, the mounting cavity is installed with a rewind box corresponding to the number of charging data cables, the rewind box is used to reel in the charging data cables, the top of the mounting cavity is installed with a top cover, the top cover is provided with a pass-through for the plug of the charging data cables to be pulled out.

As a preferred technical solution of the present invention, the mounting cavity is provided with a limit frame to limit the inward position of the plug of the charging data cable.

As a preferred technical solution of the present invention, the charging data cable is one or both of Type-C data cable and Lightning data cable.

As a preferred technical solution of the present invention, the two ends of the charging power cable are provided with charging jacks, and the charging circuit board is provided with the charging sockets that fits with the charging jacks.

As a preferred technical solution of the present invention, the chassis of the docking station is provided with a port for the charging jack to be inserted.

As a preferred technical solution of the present invention, the installation cavity is installed with negative ion generation module, control module and negative ion detection module, negative ion detection module, negative ion generation module and control module is connected, when the negative ion detection module detects that the concentration of negative ions in the air is lower than the set value, the control module controls the negative ion generation module to work to generate negative ions.

As a preferred technical solution of the present invention, the charging circuit board is connected to the control module to supply power to the control module.

The beneficial effects of the present invention are:

The telescopic docking station is equipped with a charging circuit board, a charging power cord and a plurality of charging data cables are connected to the charging circuit board, and the docking station is equipped with a rewind box that corresponds to the number of charging data cables one by one. Just pull out the plug of the charging cable to work. Users can still charge their electronic devices when they forget to bring the cable. And if it is not in use, the charging cable will be coiled up in the rewind box to avoid scattering outside. The storage function will make the car environment in order. In addition, the invention also integrates the negative ion detection module, control module and negative ion generation module in the docking station. When the negative ion detection module detects that the concentration of negative ions in the air is lower than the set value, the control module controls the negative ion generation module to work to generate negative ions, thus effectively improving the air quality inside the car.

### BRIEF DESCRIPTION OF THE FIGURES

The attached figures will describe the present invention further. They form part of the specification together with the embodiments of the invention for the purpose of explaining the invention and do not constitute a limitation of the invention. In the attached figures:

FIG. 1 is a schematic diagram of the structure of a telescopic docking station of the present invention; and

FIG. 2 is a schematic diagram of the structure within the mounting cavity of a telescopic docking station of the present invention; and

FIG. 3 is a schematic diagram of the structure of the charging power cord of a telescopic docking station of the present invention; and

FIG. 4 is a schematic diagram of the structure of the jack of a telescopic docking station of the present invention; and

FIG. 5 is a schematic diagram of the structure of the pass-through of a telescopic docking station of the present invention.

In the figures: 1. docking station chassis; 2. charging circuit board; 3. charging power cable; 4. charging data cable; 5. rewind box; 6. top cover; 7. limit frame; 8. charging jack; 9. charging socket; 10. anion generation module; 11. anion detection module; 12. control module; 13. port; 14. pass-through; 15. anion brush.

### DESCRIPTION OF THE INVENTION

Preferred embodiments of the invention are described below with reference to the attached figures. and it should be clear that the preferred embodiments described herein are for the purpose of illustrating and explaining the invention only, and are not intended to limit the invention.

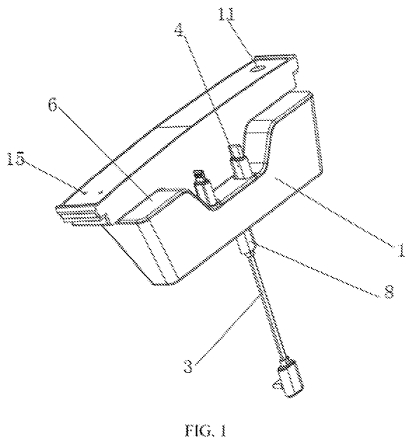

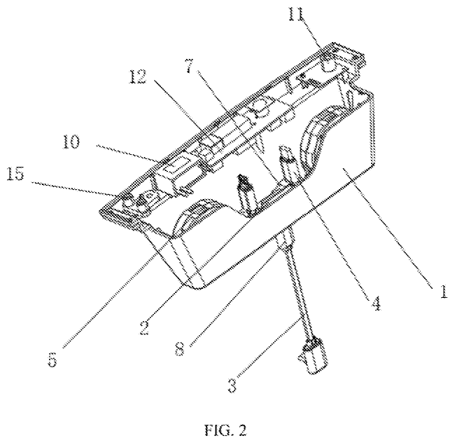

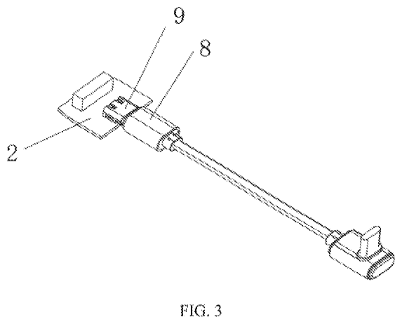

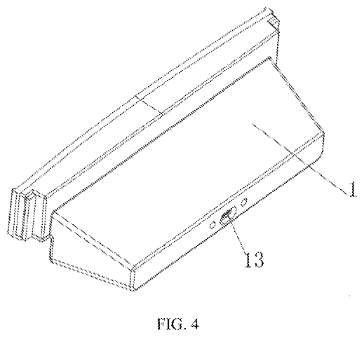

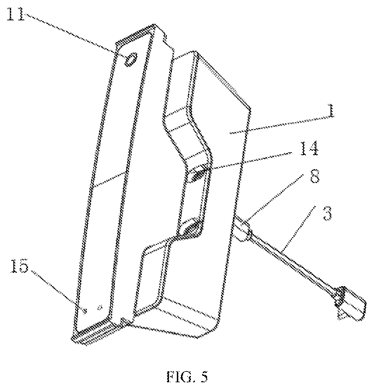

Embodiment: As shown in FIGS. 1-5, the present invention is a telescopic docking station, including a docking station chassis 1, the docking station chassis 1 is provided with a mounting cavity, a charging circuit board 2 is installed inside the mounting cavity, a charging power cable 3 and a plurality of charging data cables 4 are connected to the charging circuit board 2, a rewind box 5 is installed inside the mounting cavity corresponding to the number of charging data cables 4. the rewind box 5 is used to rewind the charging data cables 4, the top of the mounting cavity is provided with a top cover 6, the top cover 6 is provided with a pass-through 14 for the plug of the charging data cables 4 to be pulled out. The docking station is equipped with a charging circuit board 2, a charging power cable 3 and a plurality of charging data cables 4 are connected to the charging circuit board 2, and the docking station is equipped with a rewind box 5 that corresponds to the number of charging data cables 4 one by one. Just pull out the plug of the charging data cable 4 to work. If the user forgets to carry the data cable, it can still charge the electronic devices. If it is not used, the charging data cable 4 will be coiled by the rewind box 5 to avoid scattering the charging data cable 4 outside. The stowage function will make the car interior in order. Rewind box is an existing technical product available commercially. There are a variety of related products on the market, of which the type of rewind box is optional.

The mounting cavity is provided with a limit frame 7 to limit the plug of the charging data cable 4 inward to limit the plug of the charging data cable 4 to prevent the plug of the charging data cable 4 from retracting into the mounting cavity under the action of the rewind box and being difficult to pull out.

The charging data cables are one or both of Type-C data cables and Lightning data cables to meet the charging needs of mobile devices such as cell phones available on the market.

The charging power cable 3 is provided with charging jacks 8 at both ends, and the charging circuit board 2 is provided with a charging socket 9 that fits with the charging jacks 8; one end of the charging power cable 3 is a Type-C right-angle plug connected to the charging circuit board 2, and the other end of the charging power cable 3 is a Type-C curved plug electrically connected to the vehicle power supply.

The docking station chassis 1 is provided with a port 13 for the charging jack 8 to be inserted.

As another solution of the present invention, the installation cavity is also installed with negative ion generation module 10, control module 12 and negative ion detection module 11, negative ion detection module 11, negative ion generation module 10 and control module 12 connected, when the negative ion detection module 11 detects that the concentration of negative ions in the air is lower than the set value, the control module 12 control negative ion generation module 10 work to generate negative ions. The negative ion detection module 11, negative ion generation module 11, and control module 12 are all prior art products that have been widely used in automotive vehicle air purifiers, so the specific circuit structure is not detailed here, and the technical solution is clear and complete for those in the art to which it belongs.

The charging circuit board 2 is connected to the control module 12 to supply power to the control module 12, the negative ion detection module 11, the negative ion generation module 10 is connected to the control module 12, and the control module 12 supplies power to the negative ion detection module 11 and the negative ion generation module 10; the negative ion generation module 10 is equipped with two negative ion brush 15, and the negative ion detection module 11, the control module 12 and the negative ion generation module 10 integrated in the docking station, when the negative ion detection module 11 detects that the concentration of negative ions in the air is lower than the set value, the control module 12 controls the negative ion generation module to work to generate negative ions, thus effectively improving the air quality inside the car.

The top cover is provided with a through hole for the negative ion brush 15 on the negative ion generation module 10 to protrude, and a protrusion hole for the detection head of the negative ion detection module 11 to protrude, so that the negative ion detection module 11 and the negative ion generation module 10 are in contact with outside air. The top cover is provided with a display module and a control button module connected to the control module.

Finally, it should be noted that the above is only a preferred embodiment of the present invention, and is not intended to limit the invention. Despite the detailed description of the invention with reference to the preceding embodiments, it is still possible for a person skilled in the art to modify the technical solutions recorded in the preceding embodiments or to make equivalent substitutions for some of the technical features. Any modification, equivalent substitution, improvement, etc. made within the spirit and principles of the present invention shall be included in the scope of protection of the present invention.

What is claimed is:

1. A telescopic docking station, characterized in that it includes a docking station chassis, the docking station chassis is provided with a mounting cavity, and a charging circuit board is installed inside the mounting cavity, the charging circuit board is connected to a charging power cable and a plurality of charging data cables,
wherein a rewind box is installed inside the mounting cavity corresponding to the number of charging data cables, the rewind box is used to reel in the charging data cables,
wherein the top of the mounting cavity is installed with a top cover, and the top cover is provided with a pass-through port for the plug of the charging data cables to pull out.

2. A telescopic docking station according to claim 1, characterized in that the mounting cavity is provided with a limit frame that limits the plug of the charging data cable inwards.

3. A telescopic docking station according to claim 1, characterized in that the charging data cable is one or both of Type-C data cable and Lightning data cable.

4. A telescopic docking station according to claim 1, characterized in that the charging power cable is provided with charging jacks at both ends, and the charging circuit board is provided with a charging socket that fits with the charging jacks.

5. A telescopic docking station according to claim 4, characterized in that the chassis of the docking station is provided with a port for the charging jack to be inserted.

6. A telescopic docking station according to claim 1, characterized in that the installation cavity is also installed in the negative ion generation module, control module and negative ion detection module, negative ion detection module, negative ion generation module and control module connected, when the negative ion detection module detects that the concentration of negative ions in the air is lower than the set value, the control module controls the negative ion generation module to work to generate negative ions.

7. A telescopic docking station according to claim 6, characterized in that the charging circuit board is connected to the control module to supply power to the control module.
